(19) United States
(12) Patent Application Publication
(10) Pub. No.: US 2026/0018923 A1
(43) Pub. Date: Jan. 15, 2026

(54) Controller Protection Circuit for Solar Cell Connected to Charge a Battery

(71) Applicant: Kirk NationalLease Co., Sidney, OH (US)

(72) Inventors: Jeffery A. Phlipot, Fort Loramie, OH (US); Mitchell S. Rank, Sidney, OH (US); Kristopher A. Phlipot, Saint Paris, OH (US)

(73) Assignee: Kirk NationalLease Co., Sidney, OH (US)

(21) Appl. No.: 18/944,710

(22) Filed: Nov. 12, 2024

Related U.S. Application Data
(60) Provisional application No. 63/669,036, filed on Jul. 9, 2024.

(51) Int. Cl. H02J 7/35; H02H 7/20; H02J 7/00

(52) U.S. Cl. CPC H02J 7/35; H02H 7/20; H02J 7/0029

(57) ABSTRACT

A protective interconnection circuit for interconnecting a solar panel, a battery and a charge controller. One embodiment has a pair of post-mate, mating electrical connectors. The connectors have at least two primary conduction paths through the joined connectors and a first set of at least two auxiliary conduction paths through the joined connectors. The primary conduction paths electrically connect the battery to the charge controller. The auxiliary conduction paths of the battery side connector are connected together. The auxiliary conduction paths of the controller side connector are connected one to the solar panel and the other to the charge controller. Another embodiment has a relay with its coil terminals electrically connected the controller's battery terminals. The relay contacts are interposed in a conductive connection between the solar panel and the controller.

### CROSS-REFERENCE TO RELATED APPLICATIONS

This application claims the benefit of U.S. Provisional Application No. 63/669,036 filed Jul. 9, 2024.

### BACKGROUND OF THE INVENTION

Solar energy incident upon photo-voltaic solar panels has been recognized as a resource for charging a battery that is used to power mobile power equipment as well as many diverse other electrically powered equipment, both mobile and stationary. As well known in the prior art, solar panels comprise an array of multiple, semiconductor, photo-voltaic cells, often referred to as PV cells. The terms solar panel, solar cell, photo-voltaic cell and PV cell are used interchangeably and equivalently in this description because the described invention is useful with single or multiple photo-voltaic devices.

One example of a use for a solar panel battery charging circuit is to charge the storage battery of a battery-powered pallet lift that is mounted on a vehicle for loading and unloading cargo. Other examples include domestic solar power systems for providing electrical service to buildings or even charging the batteries of electric vehicles. Any reader of this document undoubtedly can think of numerous additional examples of solar battery charging applications for which the present invention can be used.

Circuits for maintaining a charge on a battery typically include a charge controller, the photo-voltaic solar panel and a mating pair of connectors for manually connecting the battery with the circuit. The controller has two principal purposes. One purpose is to have its solar panel charge the battery when the battery is discharged below a predetermined level and adequate voltage is available from the solar panel. The other purpose is to prevent overcharging of the battery. In normal operation the battery and the solar cell are both connected to the controller.

At times it is necessary to disconnect the battery from the circuit, for example to be recharged by other charging equipment or to be replaced. However, the controller can be damaged if the battery is removed while the solar panel remains connected to the controller. The reason is that the battery provides power to operate the controller. If the solar panel is connected to the controller when the battery is not, the solar panel may supply an inadequately low, excessively high and/or unstable voltage to the controller and cause the controller circuit to operate improperly and be damaged.

Therefore, a charge controller has a sequence in which it should be safely disconnected from, or connected to, the solar panel. Specifically, the solar panel should not be in connection with the controller at any time that the battery is not in connection with the controller. Consequently, whenever the battery is to be disconnected from the controller, the solar cell should be disconnected preferably before the battery is disconnected but at least simultaneously with disconnection of the battery. When reconnecting a battery, the reverse sequence is desirable; that is, the battery should be connected to the controller, preferably before the solar panel is connected but at least simultaneously with connection of the solar panel. Although the solar panel is connected to the controller by two, opposite-polarity conduction paths, it is only necessary to break one of the two conduction paths to electrically isolate the solar panel for protecting the controller.

The need to disconnect a solar panel from the controller before disconnecting the battery has been recognized in the prior art. The common practice is to rely on a human worker to remember to open the circuit to the solar cell, such as by disconnecting a solar panel connector from the controller, before the worker disconnects the battery. Unfortunately, humans occasionally forget and disconnect the battery without first disconnecting the solar panel which sometimes results in damage to the controller.

The most common solutions appear to be warnings in the equipment documentation, a warning label on the controller or a transfer switch which allows a person to actuate the switch and thereby disconnect the solar panel. The solar panel is usually connected to the controller with a manually disconnectable connector which a worker can disconnect before the battery is disconnected. But all of these solutions rely on a human worker remembering to take the appropriate action before disconnecting the battery.

The purpose of the invention is to automatically disconnect the solar cell from the controller when (and preferably some milliseconds before) the battery is disconnected from the circuit. That way it is not necessary to rely on a worker remembering to do so.

A further purpose of the invention is to automatically assure that, when a battery is first connected or reconnected to the controller, the solar panel is not already connected to the controller. Preferably, the solar panel is only connected to the controller after a time delay following electrical connection of the battery.

A still further purpose of the preferred embodiment of the invention is to provide a protective circuit that is not dependent upon a sensing circuit which could itself fail or not operate because of insufficient battery voltage.

A further purpose of the invention is to provide an embodiment of the invention which inherently provides a time delay that disconnects the solar panel from the controller before the battery is disconnected and inversely also provides a time delay that reconnects the solar panel to the controller only after the battery is reconnected to the controller.

Yet another purpose of the invention is to provide an embodiment of the invention that is inherently fail-safe because its operation is not dependent on battery voltage or any active electronic or electrical components, such as semiconductor logic circuits or electromechanical devices, that would result in failure if the battery was sufficiently discharged that the electronic or electromagnetic component would not operate or the active component failed.

Terminology. The fundamental components of a solar battery charging circuit are the solar panel, the charge controller, often just referred to as the controller, and the battery. However, the battery has battery “terminals” and the controller also has “battery” terminals which are intended for connection of the battery to the controller. Similarly, the solar panel has terminals and the controller has solar panel terminals which are intended to be connected to the solar panel. In order to distinguish the terminals of the battery itself from the “battery” terminals of the controller, the word controller is inserted as an adjective before the words “terminal” or “terminals”. So there are “battery terminals” and “battery controller terminals”. Similarly, there are “solar panel terminals” and “solar panel controller terminals”.

Additionally, the battery is connected to the charge controller through a “mating pair of connectors”, which refers to two connectors that can be manually connected and manually disconnected. The two individual connectors, when connected, have multiple “conduction paths” through the connectors when the individual connectors are engaged together. The mating pair of connectors can be viewed as a boundary between a battery side of the circuit and a controller side of the circuit. One of the two connectors is for electrical connection directly to the battery or an assembly of multiple batteries. That connector is referred to as the “battery side connector” because it is electrically connected to the battery side of the circuit. The conduction paths through the other connector are electrically connected to the charge controller or to the interposed protection circuit. That other connector is referred to as the “controller side connector” because it is electrically connected to the controller side of the circuit.

### SUMMARY OF THE INVENTION

The invention is a protective interconnection circuit for interconnecting a solar panel, a battery and a charge controller. One preferred embodiment has a pair of mating electrical connectors, one being a battery side connector and the other being a controller side connector. The pair of mating connectors has at least two primary conduction paths through the joined connectors and also a first set of at least two auxiliary conduction paths through the joined connectors. The primary conduction paths of the battery side connector are electrically connected to the battery. The primary conduction paths of the controller side connector are connected to the battery controller terminals of corresponding polarity. The first set of auxiliary conduction paths of the battery side connector are electrically connected together. A first one of the first set of auxiliary conduction paths through the controller side connector is electrically connected to a first one of the solar panel terminals having a first polarity. The other conduction path of the first set of auxiliary conduction paths through the controller side connector is connected to a solar panel controller terminal having the same first polarity.

A second embodiment of the invention is also a protective interconnection circuit for interconnecting a solar panel, a battery and a charge controller. An electrically actuated switch, preferably a relay, has a pair of input terminals for actuating the switch and a pair of switching terminals, such as relay contacts, for making and breaking a conduction path between the switching terminals. The input terminals for actuating the switch are electrically connected one to each of the controller's battery terminals. A first one of the switching terminals is electrically connected to a first one of the solar panel terminals having a selected polarity. The second one of the switching terminals is electrically connected to a solar panel controller terminal having the same selected polarity as the first one of the solar panel terminals.

### BRIEF DESCRIPTION OF THE DRAWINGS

FIG. 1 is a simplified block diagram of a “relay” embodiment of the invention which is simplified for illustrating its circuit and operating principles.

FIG. 2 is a schematic diagram of the preferred “relay” embodiment of the invention.

FIG. 3 is a simplified block diagram of an “auxiliary loop” embodiment of the invention which is simplified for illustrating its circuit and operating principles.

FIG. 4 is a schematic diagram of the preferred “auxiliary loop” embodiment of the invention.

FIG. 5 is a diagram illustrating the principles of operation of a post-mate mating connector pair and also illustrating one of multiple possible physical configurations for a post-mate, mating connector pair.

FIG. 6 is a view in perspective of a preferred, female, post-mate connector.

FIG. 7 is a view in perspective of a preferred, male, post-mate connector.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

U.S. Provisional Application No. 63/669,036 filed Jul. 9, 2024 is incorporated in this application by reference.

There are two embodiments of the invention that are shown and described. One is designated a “relay” embodiment and the other is designated an “auxiliary loop” embodiment. Both use the general principle of detecting whether the battery is connected and, if the battery is not connected, opening at least one of two conductive paths between the charge controller and the solar panel. The relay embodiment detects battery disconnection by sensing the battery voltage applied to the controller, typically 0 volts when the battery is not connected, and battery voltage when the battery is connected. The relay embodiment preferably uses an electromagnetic relay with mechanical contacts. Although the relay embodiment is described and illustrated as physically located externally of the charge controller in the manner of an aftermarket product, it will become apparent to those skilled in the art that the relay embodiment circuit components can alternatively be located within the charge controller as a part of the charge controller circuit.

The auxiliary loop embodiment mechanically senses disconnection of the battery from the physical status of the mating connector pair that is used to connect the battery to the controller. The preferred embodiment of the auxiliary loop embodiment has a mating connector pair that has three statuses. A first status is that the conductive paths through the mating connectors are all connected. The second status is that the conductive paths which are connected to the battery are both connected and auxiliary conductive paths through the connector are not connected. The third status is that the conductive paths through the connectors are all disconnected. When the mating connectors are manually disconnected by a worker, the mating connectors progress sequentially from the first status to the second status and then to the third status. They progress in the opposite sequence when the mating connectors are manually reconnected by a worker.

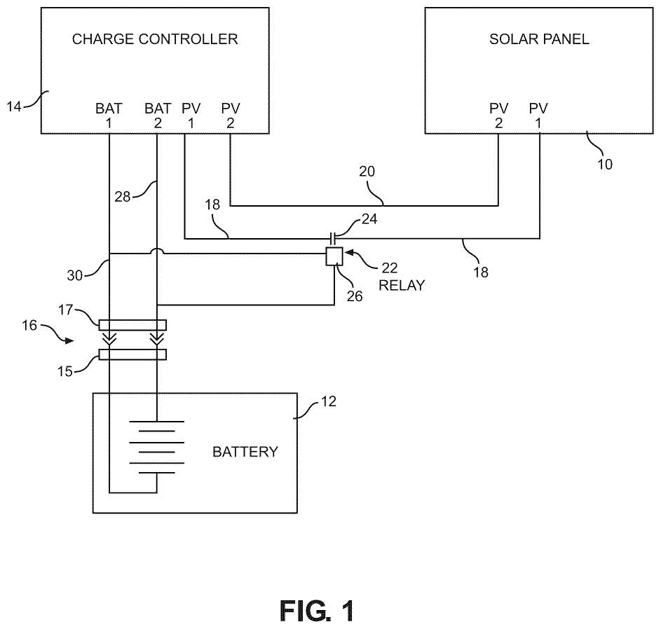

FIG. 1 illustrates a “relay” embodiment of the invention in a schematic circuit diagram that is simplified for facilitating the understanding of its principles of construction and operation. The circuit has the conventional three components of a solar battery charging circuit, namely, a solar panel 10, a battery 12 and a charge controller 14. The battery 12 is connected to battery controller terminals BAT 1 and BAT 2 of the charge controller 14 through a conventional mating connector pair 16. The connector pair 16 comprises a controller side connector 17 and a battery side connector 15 which are manually separable in the conventional manner. The solar panel 10 is connected to solar panel controller terminals PV 1 and PV 2 of the charge controller 14 through two conductors 18 and 20.

The circuit uses an electrically actuated switch for, at times, opening the circuit through at least one of the two conductors 18 and 20 which connect the solar panel 10 to the charge controller 14. The preferred electrically actuated switch is a normally open relay 22. The relay 22 has relay contacts 24 which serve as switching terminals which are electrically interposed in at least one of the two conductors 18 and 20 for at different times opening the circuit through the conductor in which the relay contacts 24 are interposed. The polarity of the solar panel connections is intentionally not indicated because the relay contacts 24 can be interposed in either conductor 18 or 20. Alternatively, the relay 22 can have two pairs of contacts with one pair interposed in each of the conductors 18 and 20. The actuator 26 of the relay 22, which commonly is an electromagnet, has its input terminals connected to the conductors 28 and 30 which connect the charge controller side of the mating connectors 16 to the controller's battery terminals BAT 1 and BAT 2. As persons skilled in the art will recognize, some electrical circuits have a common ground. So a charge controller 14 may have only three terminals with one of the three terminals serving as both a battery controller terminal and a solar panel controller terminal of the same polarity.

The operation of the circuit of FIG. 1 can be described beginning with the mating connector pair 16 mutually engaged so that the charge controller 14 is connected to both the battery 12 and the solar panel 10. In that state the battery voltage is applied to the relay actuator 26 so the relay contacts 24 are closed. With the relay contacts 24 closed, the solar panel 10 is electrically connected to the charge controller 14 and the circuit is in normal operation.

In the event that a worker separates the connectors of the mating connector pair 16, the battery voltage is interrupted and the voltage to the relay actuator 26 drops to 0 volts. Therefore, the relay contacts 24 open which disconnects at least one conduction path of the solar panel 10 from the charge controller 14 to protect the charge controller 14 from being damaged by continued connection after the battery 12 is disconnected. The solar panel 10 remains disconnected so long as the battery 12 remains disconnected. When a battery is reconnected to the battery side connector 15 of the mating connector pair 16 and the mating connectors 16 are engaged together, battery voltage is applied to the relay actuator 26, the contacts 24 are therefore closed and the battery 12 and the solar panel 10 both become reconnected to the charge controller 14.

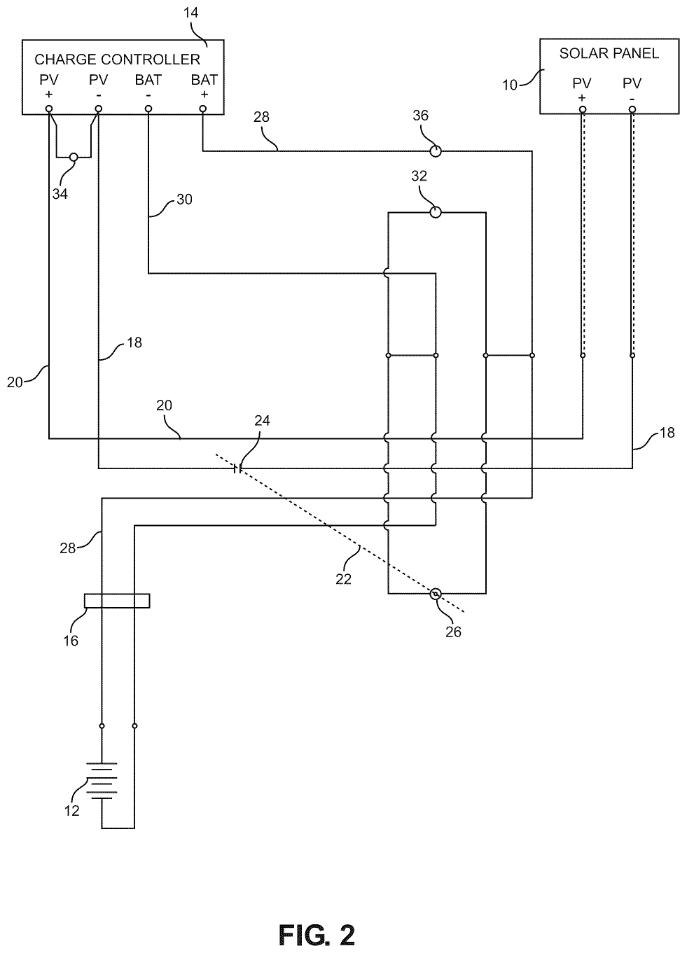

FIG. 2 illustrates a practical application of the principles illustrated by the circuit of FIG. 1. The component parts illustrated in FIG. 2 have the same reference numbers as the corresponding parts shown in FIG. 1 and they are electrically connected together in the same manner. Consequently, a description of them is not repeated. The circuit of FIG. 2 has a volt meter 32 for displaying the battery voltage when the battery is connected to the circuit by the mating connector pair 16. A solar panel charging indicator light 34 is electrically connected across the solar panel controller terminals PV+ and PV− to signal when the solar panel 10 is applying a voltage to those terminals. A circuit breaker 36 is interposed in a battery conductive path for protecting the circuit from excessive battery current.

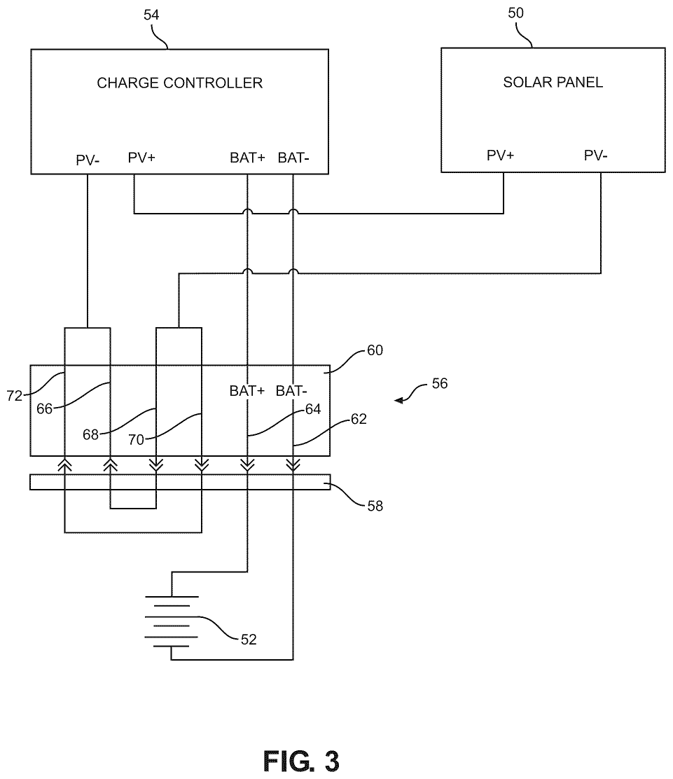

FIG. 3 illustrates an “auxiliary loop” embodiment of a protective interconnection circuit of the invention in a schematic circuit diagram that is simplified for facilitating the understanding of its principles of construction and operation. The interconnection circuit connects together a solar panel 50, a battery 52 and a charge controller 54. The solar panel 50 has a positive polarity terminal PV+ and a negative polarity terminal PV−. The battery 52 has positive and negative polarity terminals indicated by the battery symbol. The charge controller 54 has a positive polarity solar panel controller terminal PV+, a negative polarity solar panel controller terminal PV−, a positive polarity battery controller terminal BAT+ and a negative polarity battery controller terminal BAT−. Although the preferred set of 4 charge controller terminals are illustrated, the protective interconnection circuit could have only three terminals with one of the three terminals serving as a common ground for both a battery controller terminal and a solar panel controller terminal which have the same polarity.

A pair 56 of mating electrical connectors comprises a battery side connector 58 and a controller side connector 60. The pair 56 of mating connectors 58 and 60 has at least two primary conduction paths 62 and 64 through the joined connectors 58 and 60. The pair 56 of mating connectors 58 and 60 also has a first set of at least two auxiliary conduction paths 66 and 68 through the joined connectors. Preferably there are at least two additional auxiliary conduction paths 70 and 72 through the joined connectors 58 and 60.

The primary conduction paths 62 and 64 of the battery side connector 58 are electrically connected to the battery 52. The primary conduction paths 62 and 64 of the controller side connector 60 are connected to the battery controller terminals BAT+ and BAT− of corresponding polarity.

The first set of two auxiliary conduction paths 66 and 68 of the battery side connector 58 are electrically connected together. One of the first set of auxiliary conduction paths 66 and 68 of the controller side connector 60 is electrically connected to a first one of the terminals of the solar panel having a first polarity. In the example illustrated in FIG. 3, the conduction path 68 is connected to the solar panel terminal PV−. The other of the first set of auxiliary conduction paths 66 and 68 of the controller side connector 60 is connected to a solar panel controller terminal having the first (same) polarity. In the example illustrated in FIG. 3, the auxiliary conduction path 66 is connected to the solar panel terminal PV−. The additional auxiliary conduction paths 70 and 72 through the joined connectors 58 and 60 are connected together at or in the battery side connector 58. The additional auxiliary conduction paths 70 and 72 at the controller side connector 60 are connected electrically the same as the first set of auxiliary conduction paths 66 and 68.

The above circuit arrangement of the four auxiliary conduction paths 66, 68, 70 and 72 provides two parallel conduction paths from the solar panel's PV− terminal to the controller's PV− terminal when the two connectors 58 and 68 are connected together. Only two auxiliary conduction paths though the connector pair 56 are required because they would provide a conduction path from the solar panel's PV− terminal to the controller's PV− terminal when the two connectors 58 and 68 are connected together. However, there are advantages in having four auxiliary conduction paths instead of two. One advantage is that the use of two parallel conduction paths is that they provide a higher maximum current rating for current between the solar panel and the charge controller than having only one conduction path. Another advantage is that the redundancy of having two parallel conduction paths improves reliability. In the event of failure of one of the parallel auxiliary conduction paths, for example because of wear or an accumulation of dirt or corrosion, the other current conduction path can still conduct.

The operation of the circuit of FIG. 3 can similarly be described beginning with the mating pair 56 of connectors 58 and 60 engaged together and the charge controller 54 connected to both the battery 52 and the solar panel 50. In that state the battery voltage is applied to the charge controller 54 and the solar panel 50 can supply electrical power to the charge controller 54. The circuit is in normal operation.

If a worker disengages the battery side connector 58 from the controller side connector 60, both the battery 52 and the solar panel 50 are disconnected from the charge controller 54. The battery is automatically disconnected by opening of the primary conduction paths 62 and 64 resulting from separation of the connectors 58 and 60. The solar panel 50 is also automatically disconnected from the controller 54 by opening the connectors' auxiliary conduction paths 66 and 68 and, if present, opening of the auxiliary conduction paths 70 and 72. The worker need take no action prior to the separation of the connectors 58 and 60. After separation of the connectors, the battery can be removed.

Similarly, when a battery is to be reconnected, the battery is reconnected to the battery side connector 58 and the pair of mating connectors 58 and 60 are then reengaged. This reengagement returns the charging circuit, the protection circuit and the battery to their operational state.

Time delay. With some electrical circuits, particularly those with inductive or capacitive components, the disconnection and/or the connection of an electrical current path can cause a transient current or voltage spike transient in the circuit. If sufficiently large, a transient can damage one or more circuit components of the controller. Although circuits which prevent or diminish such electrical transients are generally known, a mating pair of connectors 56 can be used which provide an additional protection feature. The additional protection is a time delay between the time of electrical disconnection or connection of the solar panel from or to the charge controller to the time of disconnection or connection of the battery from or to the charge controller. Transient voltages and/or currents will be reduced or die out during the time delay.

A preferred mating pair of connectors that can be used to provide this additional time delay protection is a post-mate connector. A post-mate connector pair that can be used to implement the invention has as least two primary conductions paths through the joined connectors and at least two auxiliary conduction paths through the joined connectors. With a post-mate connector pair, during connective insertion of the mating connectors together, their primary conduction paths are electrically connected together at a lesser distance of insertion (connectors are farther apart) than the distance of insertion at which an auxiliary conduction paths are electrically connected together. Consequently, the times at which the respective primary conduction paths and the auxiliary conduction paths are connected together are dependent upon the speed of physical motion of the worker engaging or disengaging the two connectors. As a result, when the connectors are disengaged by a worker, there is a time delay of some milliseconds, from the time the auxiliary conduction paths, which are connected to the solar panel, are opened until the time that the primary conduction paths connected to the battery are opened. This time delay means that, when the connectors are disengaged, the solar panel is first disconnected from the charge controller and at a later time the battery is disconnected from the charge controller. Desirably, when the connectors are engaged by a worker, the primary conduction paths connected to the battery are first connected together and, after a time delay, the auxiliary conduction paths, which are connected to the solar panel, are subsequently connected together. In summary, during disengagement of the connectors by a worker, the solar panel is first disconnected from the charge controller and, after the time delay, the battery is disconnected from the charge controller. During reengagement of the connectors, the battery is first connected to the charge controller and, after a time delay, the solar panel is connected to the charge controller. This time delay provides a time interval in both directions of connector motion during which any transients have time to diminish or die out and not cause damage.

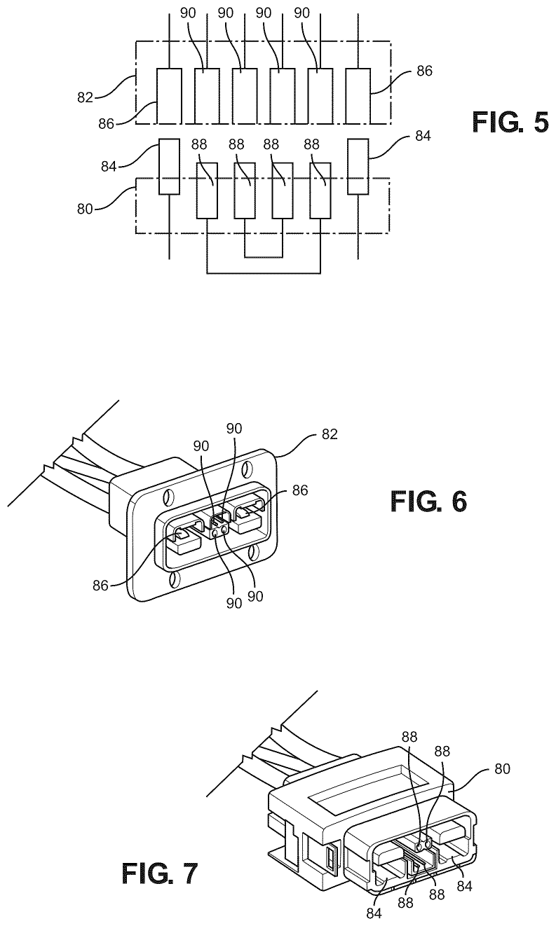

FIGS. 5, 6 and 7 illustrate examples of post-mate connectors although other configurations of post mate connectors are known in the prior art. FIG. 5 shows a diagrammatic illustration of an example of a post-mate mating connector pair that illustrates its operation. Referring to FIG. 5, a battery side connector 80 has pins (or prongs) 84 and 88 and a controller side connector 82 has mating sockets 86 and 90. Pins 84 of the battery side connector 80 engage with sockets 86 of the controller side connector 82 to establish a primary conduction path through the connectors for connection of the battery. Pins 88 of the battery side connector 80 engage with sockets 90 of the controller side connector 82 to establish auxiliary conduction paths through the connectors 80 and 82 for connection of a solar panel to a controller.

The primary pins 84 protrude out farther and beyond the auxiliary pins 88. As the connectors 80 and 82 are moved closer together, the primary pins 84 will enter the primary sockets 86 and establish electrical connection before the auxiliary pins 88 enter the auxiliary sockets 90 and establish electrical connection. As the connectors 80 and 82 continue to be moved together, the auxiliary pins 88 will eventually enter the auxiliary sockets 90 to establish their electrical connection. In this way all of the conduction paths through the connectors 80 and 82 are established but with a time delay after establishment of the primary conduction path until establishment of the auxiliary conduction path through the connectors 80 and 82.

Inversely, as the connectors 80 and 82 are separated, the auxiliary conduction paths through the connectors 80 82 will first be interrupted and opened. Then, as the connectors continue to be separated and after a time delay, the primary conduction paths through the connectors 80 and 82 will be interrupted and opened.

FIG. 6 is a view of a preferred, female, post-mate connector preferably used as the controller side connector. FIG. 7 is a view in perspective of a preferred, male, post-mate connector preferably used as the battery side connector and mating with the female connector illustrated in FIG. 6. The connectors, their primary pins and sockets and their auxiliary pins and sockets are designated with the same reference numbers used in FIG. 5.

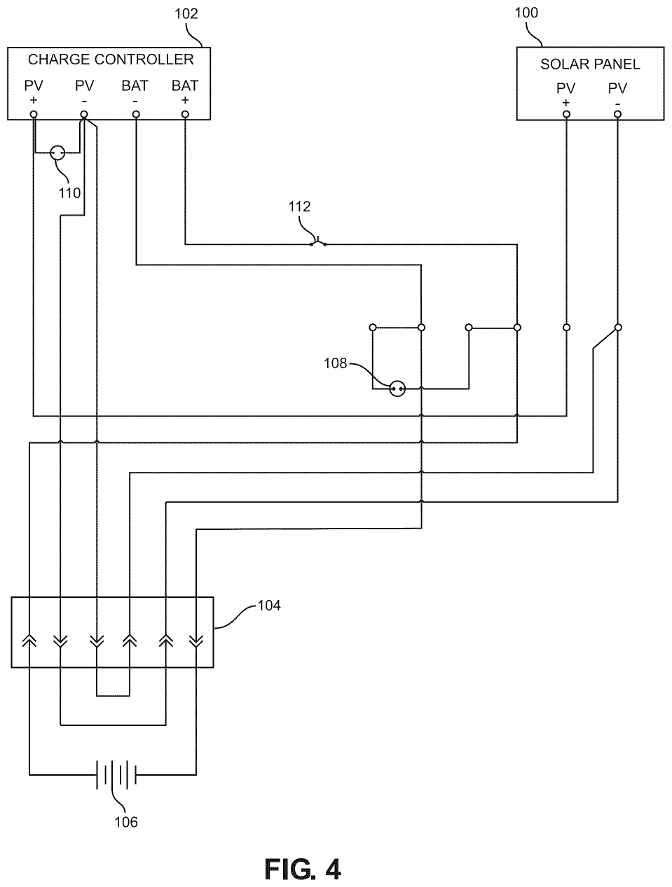

FIG. 4 illustrates a more practical embodiment of the auxiliary loop embodiment that is electrically connected in the same manner as the circuit of FIG. 3. It has a solar panel 100, a charge controller 102, a mating connector pair 104, which is preferably a post-mate connector pair and a battery 106. The circuit of FIG. 4 has a volt meter 108 for displaying the battery voltage when the battery is connected to the circuit by the mating connector pair 104. A solar panel charging indicator light 108 is electrically connected across the solar panel controller terminals PV+ and PV− to signal when the solar panel 100 is applying a voltage to those terminals. A circuit breaker 112 is interposed in a battery conductive path for protecting the circuit from excessive battery current.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

### REFERENCE NUMBERS

10 solar panel
12 battery
14 charge controller
16 mating connector pair
18 conductor
20 conductor
22 relay
24 relay contacts
26 relay actuator/coil
28 conductor
30 conductor
32 voltmeter
34 solar panel charging indicator light
36 circuit breaker
50 solar panel
52 battery
54 charge controller
56 mating pair of electrical connectors
58 battery side connector
60 controller side connector
62, 64 primary conduction paths through connector pair 56
66, 68 first set of auxiliary conduction paths
70, 72 additional auxiliary conduction paths
80 battery side connector
82 controller side connector
84 primary pins
86 primary sockets
88 auxiliary pins
90 auxiliary sockets
100 solar panel
102 charge controller
104 mating connector pair
106 battery
108 voltmeter
110 solar panel charging light indicator
112 circuit breaker

1. A protective interconnection circuit for interconnecting a solar panel, a battery and a charge controller, the solar panel and the battery each having a positive polarity terminal and a negative polarity terminal and the charge controller having a positive polarity solar panel controller terminal, a negative polarity solar panel controller terminal, a positive polarity battery controller terminal and a negative polarity battery controller terminal, the protective interconnection circuit comprising:
(a) a mating pair of electrical connectors, one of said pair being a battery side connector and the other of said pair being a controller side connector, the mating pair of connectors having at least two primary conduction paths through the joined connectors and at least two auxiliary conduction paths through the joined connectors, wherein
(i) the primary conduction paths of the battery side connector are configured for electrical connection to the battery;
(ii) two auxiliary conduction paths of the battery side connector are electrically connected together;
(iii) the primary conduction paths of the controller side connector are configured for connection to the battery controller terminals of corresponding polarity; and
(iv) one of the connected-together auxiliary conduction paths of the controller side connector is configured for electrical connection to one of the terminals of the solar panel and the other of the connected-together auxiliary conduction paths of the controller side connector is configured for connection to a solar panel controller terminal.

2. A protective interconnection circuit for interconnecting a solar panel, a battery and a charge controller, the solar panel and the battery each having a positive polarity terminal and a negative polarity terminal and the charge controller having a positive polarity solar panel controller terminal, a negative polarity solar panel controller terminal, a positive polarity battery controller terminal and a negative polarity battery controller terminal, the protective interconnection circuit comprising:
(a) a pair of mating electrical connectors, one of said pair being a battery side connector and the other of said pair being a controller side connector, the pair of mating connectors having at least two primary conduction paths through the joined connectors and a first set of at least two auxiliary conduction paths through the joined connectors, wherein
(i) the primary conduction paths of the battery side connector are electrically connected to the battery;
(ii) two of the first set of auxiliary conduction paths of the battery side connector are electrically connected together;
(iii) the primary conduction paths of the controller side connector are connected to the battery controller terminals of corresponding polarity; and
(iv) a first one of the first set of auxiliary conduction paths of the controller side connector is electrically connected to a first one of the terminals of the solar panel having a first polarity and the other of the first set of auxiliary conduction paths of the controller side connector is connected to a solar panel controller terminal having the first polarity.

3. A protective interconnection circuit according to claim 2 wherein the pair of mating electrical connectors is a post-mate, mating connector pair for which, during connective insertion of the mating connectors together, their primary conduction paths are electrically connected together at a lesser distance of insertion than the distance of insertion at which the auxiliary conduction paths are electrically connected together.

4. A protective interconnection circuit according to claim 3 wherein:
(a) there are at least two additional auxiliary conduction paths through the mating connectors;
(b) the two additional auxiliary conduction paths of the battery side connector are electrically connected together;
(c) the two additional auxiliary conduction paths of the controller side connector are respectively electrically connected to the same terminals of the solar panel and the solar panel controller terminal that the first set of auxiliary conduction paths are connected to
wherein, when the mating electrical connectors are connected together, the two auxiliary conduction paths provide an electrically conductive path that is electrically parallel to an electrically conductive path provided by the first set of auxiliary conductive paths.

5. A protective interconnection circuit for interconnecting a solar panel, a battery and a charge controller, the solar panel and the battery each having a positive polarity terminal and a negative polarity terminal and the charge controller having a positive polarity solar panel controller terminal, a negative polarity solar panel controller terminal, a positive polarity battery controller terminal and a negative polarity battery controller terminal, the protective interconnection circuit comprising:
(a) an electrically actuated switch including a pair of input terminals for actuating the switch and a pair of switching terminals for making and breaking a conduction path between the switching terminals, the electrically actuated switch making the conduction path in response to the application of a first voltage level to the input terminals and breaking the conduction path in response to the application of a second voltage level, including 0 volts, applied to the input terminals;
(i) wherein the input terminals for actuating the switch are electrically connected one to each of the battery terminals; and
(ii) wherein a first one of the switching terminals is electrically connected to a first one of the solar panel terminals having a selected polarity; and
(iii) wherein a second one of the switching terminals is electrically connected to a solar panel controller terminal having the same selected polarity as the first one of the solar panel terminals.

6. A protective interconnection circuit according to claim 5 wherein the electrically actuated switch is an electromagnetically actuated relay.

7. A protective interconnection circuit according to claim 6 wherein the relay is physically positioned within the charge controller and is electrically connected to charge controller circuitry.
